(19) United States
(12) Patent Application Publication
(10) Pub. No.: US 2007/0151109 A1
(43) Pub. Date: Jul. 5, 2007

(54) Hairdressing tool

(76) Inventor: Tsutomu Okazaki, Yamaguchi (JP)

Correspondence Address: WENDEROTH, LIND & PONACK, L.L.P., 2033 K STREET N. W., SUITE 800, WASHINGTON, DC, 20006-1021, US

(21) Appl. No.: 10/555,274

(22) PCT Filed: May 18, 2004
(86) PCT No.: PCT/JP04/06645

§ 371 Date: Jun. 6, 2006

(30) Foreign Application Priority Data
May 19, 2003 (JP) 2003-140446

(51) Int. Cl. B26B 21/00

(52) U.S. Cl. 30/53

(57) ABSTRACT

A hairdressing tool is provided which allows easy adjustment of the amount of hair to be cut and which allows efficient use of the blade. The hairdressing tool includes a grip 6, and razor portions 1 to 4 including the blade 3 and coupled to the grip 6. The razor portions 1 to 4 include a razor holder portion 1 coupled to the grip 6, and a blade holder 4 replaceably mounted in the razor holder portion 1 and including first protrusions formed along one side thereof and formed with cutouts 4b. The blade 3 is held by the blade holder 4 between its one and other sides. The razor portions further include a blade protector 2 having second protrusions 2a formed with cutouts 2b. The blade 3 is exposed between the adjacent first protrusions and between the adjacent second protrusions.

### TECHNICAL FIELD

The present invention relates to a hairdressing tool for combing and cutting hair.

### BACKGROUND ART

Hairstyles that give light and/or soft impressions by coloring or cutting, or hairstyles in which the tips of hairs are intentionally cut unevenly are preferred today. Such hairstyles are created using scissors and/or a razor.

Razor cutting requires a skilled hand because the amount of hair cut changes according to the force applied to the razor and the angle of the razor relative to hair. Typically, a hairdresser alternately cuts hair with a razor and removes the thus cut hair with a comb. Thus, the hairdresser has to alternately pick up the razor and the comb, which makes razor cutting troublesome.

Hairdressing tools have been proposed which cope with this problem. Patent publication 1 discloses an invention titled “hairdressing razor holder” and related to a razor which allows adjustment of the amount of hair to be cut.

The razor holder disclosed in Patent document 1 is now described with reference to FIGS. 4(a) and 4(b). FIGS. 4(a) and 4(b) show hairs cut by this razor holder.

As shown in FIG. 4(a), the hairdressing razor holder disclosed in Patent document 1 includes a body 13 provided at one end of a grip and comprising a razor 14 and a holder portion 15 holding the razor 14. The body 13 is formed with protrusions 16 protruding from one side edge thereof. Each protrusion 16 is formed with a groove 17 at its tip. Thus, when the razor is combed through hair, only hairs 18 that engage the razor 14 are cut, while hairs 18 that are received in the grooves 17 remain uncut. Thus, hairs 18 can be cut partially as shown in FIG. 4(b).

Patent document 2 discloses an invention titled “razor for cutting hair” and related to a razor for cutting hair which can reliably cut hair in areas of a predetermined width at predetermined intervals.

Patent document 3 discloses an invention titled “hairdressing tool” and related to a hairdressing tool which comprises a comb and a razor that are integral with each other.
Patent document 1: JP patent publication 10-249075A
Patent document 2: JP patent publication 2000-61175A
Patent document 3: JP patent publication 2001-300159A

### DISCLOSURE OF THE INVENTION

Problems to Which the Invention Seeks a Solution

In the invention disclosed in Patent document 1, the holder portion includes a plurality of protrusions each formed with a groove, so that hair can be partially cut. But in order to adjust the amount of hair cut, a plurality of hairdressing tools have to be prepared including protrusions having different widths from each other. Further, since portions of the blade are permanently exposed and used for cutting hair and the other portions of the blade are permanently hidden by the holder portion and not used, the hairdressing tool of this publication is discarded with some portions of the blade not used at all. This is uneconomical and can push up the cost of the hairdressing tool.

In the invention disclosed in Patent document 2, since the comb portion and the blade portion are provided close to each other, it is possible to reliably cut hair only at its portions that are desired to be cut. But like the hairdressing tool disclosed in Patent publication 1, the razor disclosed in Patent publication 2 is not designed such that the amount of hair to be cut is adjustable. Also, portions of the blade are permanently exposed and used for cutting hair and the other portions of the blade are permanently hidden by the comb portion and not used. This is uneconomical.

In the invention disclosed in Patent document 3, since the comb portion and the razor portion are coupled together through the hinge, the efficiency of hair-cutting improves. But this tool also has the same problems as mentioned above concerning Patent publications 1 and 2.

An object of the present invention is to provide a hairdressing tool which allows adjustment of the amount of hair to be cut and efficient use of the blade, thereby reducing the cost for hair-cutting.

Means to Solve the Problems

According to the present invention, there is provided a hairdressing tool comprising a grip and a razor portion including a blade and coupled to the grip, characterized in that the razor portion comprises a razor holder portion coupled to the grip, a blade holder retaining the blade and detachably mounted to the razor holder portion, the blade holder including a plurality of first comb-shaped protrusions each formed with a cutout for retaining hair, and a blade protector provided separately from the blade holder and including a plurality of second comb-shaped protrusions each formed with a cutout for retaining hair, the blade being exposed between the adjacent first protrusions and between the adjacent second protrusions, said blade holder or said blade protector being slidable such that the width of portions of said blade exposed between the adjacent first protrusions and between the adjacent second protrusions is changeable.

In this arrangement, some hairs partially engage the cutouts formed in the first and second protrusions and thus are left uncut by the blade, while the remaining hairs are cut by the portions of the blade that are exposed between the adjacent first protrusions and between the adjacent second protrusions. Further, with this arrangement, it is possible to change the width of the portions of the blade exposed between the adjacent first protrusions and between the adjacent second protrusions and thus to adjust the width of a flock of hair cut by each exposed portion of the blade.

In an aspect of the invention, one of the blade holder and the blade protector is provided with a claw with which a finger is engageable so that the one of the blade holder and the blade protector can be slid by engaging the claw with a finger.

With this arrangement, even while hair is being cut, it is possible to slide the blade holder or the blade protector with the hairdressing tool held in one hand by engaging the claw with a finger of the one hand holding the tool. According to an arrangement of the invention, the razor holder portion and the blade protector are integral with each other.

With this arrangement, it is possible to reduce the number of parts.

Advantages of the Invention

According to the invention, it is possible to cut hairs by the width equal to the width of the portions of the blade exposed between the adjacent first protrusions and between the adjacent second protrusions.

According to the invention, by adjusting the distance between the adjacent first and second protrusions, that is, by adjusting the width of the portions of the blade exposed between the adjacent first protrusions and between the adjacent second protrusions, it is possible to adjust the amount of hair to be cut. Thus, the hairdressing tool according to the present invention makes it unnecessary for a hairdresser to prepare a plurality of hairdressing tools which are different in the width of the exposed portions of the blade from each other and use them alternately.

According to the invention, since the razor holder portion and the razor protector are integral with each other, it is possible to reduce the number of parts and thus the cost of the entire tool.

### BRIEF DESCRIPTION OF THE DRAWINGS

FIG. 1(a) is a schematic view of the hairdressing tool embodying the present invention; FIG. 1(b) shows the hairdressing tool of FIG. 1(a) as seen in the direction of the arrow A in FIG. 1(a); FIG. 1(c) shows the hairdressing tool of FIG. 1(a) as seen in the direction of the arrow B in FIG. 1(a); FIG. 1(d) is a schematic view of an embodiment in which the razor holder portion 1 and the blade protector 2 are integral with each other;

FIG. 2(a) is a perspective view of the hairdressing tool of FIG. 1(a), showing its blade 3, blade holder 4 and razor holding portion 1; FIG. 2(b) is a perspective view of an embodiment in which the claw 5 of FIG. 2(a) is replaced with a different claw;

FIG. 3(a) is a schematic view of the hairdressing tool embodying the present invention, showing a state in which the blade protector 2 and the blade holder portion 4 are transversely aligned with each other; FIG. 3(b) shows hair cut by the hairdressing tool of the present invention in the state of FIG. 3(a); FIG. 3(c) is a schematic view of the hairdressing tool embodying the present invention, showing a state in which the blade protector 2 and the blade holder portion 4 are not transversely aligned with each other; FIG. 3(d) shows hair cut by the hairdressing tool of the present invention in the state of FIG. 3(c);

FIG. 4(a) shows how hair is cut using a conventional hairdressing razor holder portion; and FIG. 4(b) shows hair cut by the hairdressing tool of FIG. 4(a).

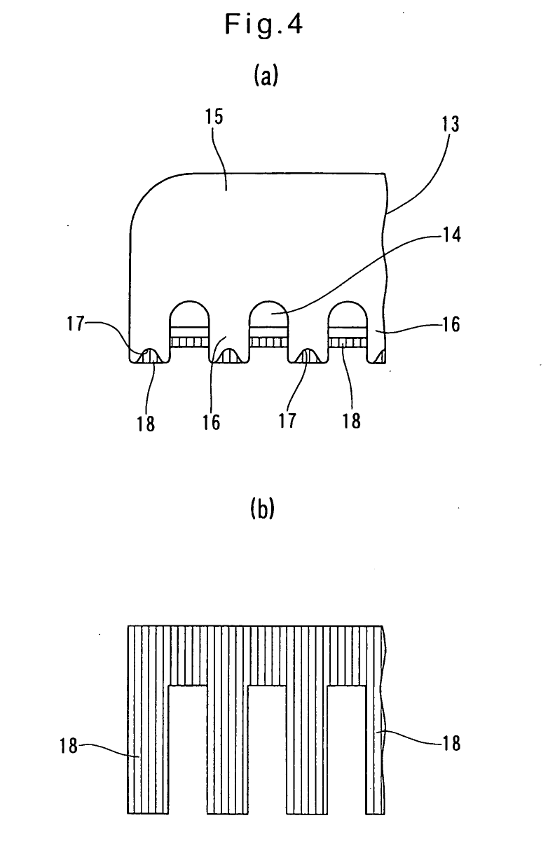

### BEST MODE FOR EMBODYING THE INVENTION

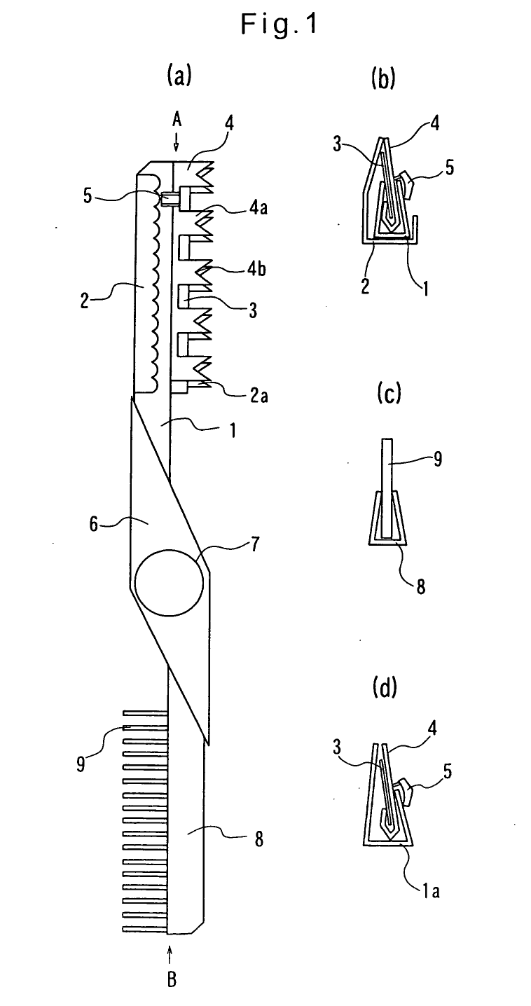

The hairdressing tool embodying the present invention is now described with reference to FIGS. 1 to 3.

FIG. 1(a) schematically shows the hairdressing tool embodying the present invention. FIG. 1(b) shows the hairdressing tool of FIG. 1(a) as seen in the direction of the arrow A in FIG. 1(a). FIG. 1(c) shows the hairdressing tool of FIG. 1(a) as seen in the direction of the arrow B in FIG. 1(a). FIG. 1(d) shows a modified embodiment in which a razor holder portion 1 and a blade protector 2 of FIG. 1(b) are integral with each other.

As shown in FIG. 1(a), the hairdressing tool comprises a grip 6, the razor holder portion 1 provided at one end of the grip 6, and a holder portion 8 provided at the other end of the grip 6. The razor holder portion 1 and the holder portion 8 detachably carry a razor unit and a comb 9, respectively.

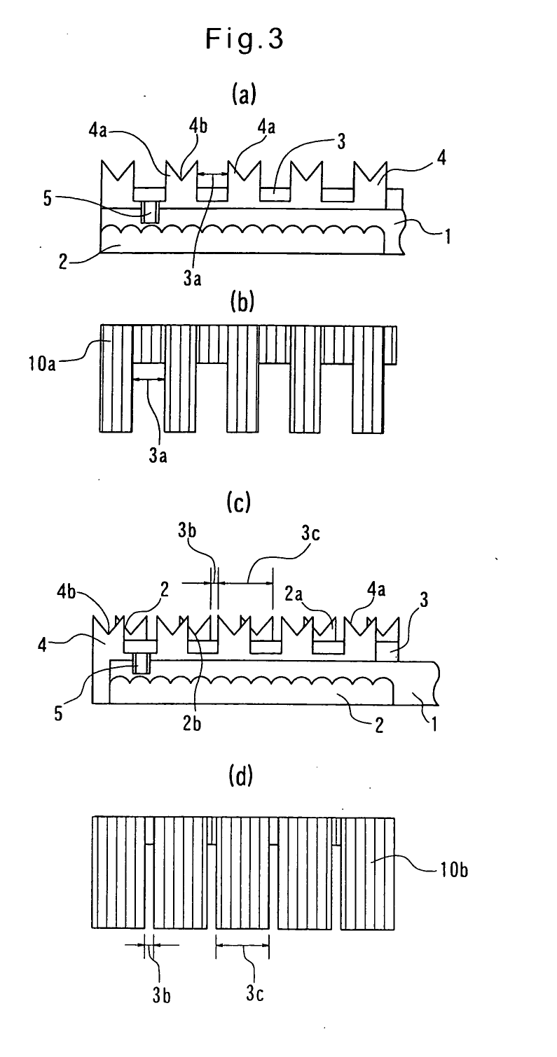

The razor unit, which is the characterizing feature of the present invention and supported on the razor holder portion 1, comprises a blade holder 4, a blade 3 held in the blade holder 4, and the blade protector 2 provided opposite to the blade holder 4 with the blade 3 disposed therebetween. The blade holder 4 and the blade protector 2 have opposed side edges along which protrusions 2a and 4a are formed, respectively. The protrusions 2a and 4a are formed with cutouts 2b and 4b, respectively. The blade holder 4 is further provided with a claw 5. By engaging the claw 5 with a finger, the blade holder 4 can be slid in the razor holder portion 1. By sliding the blade holder 4, it is possible to displace the protrusions 4a relative to the protrusions 2a, thereby adjusting the width of portions of the blade 3 that are exposed both between the adjacent protrusions 2a and between the adjacent protrusions 4a, as will be described in detail with reference to FIG. 3. The claimed razor portion includes the razor holder portion 1 and the razor unit.

As shown in FIG. 1(b), the blade holder 4 is enclosed in the razor holder portion 1 and can be removed therefrom by sliding it in the razor holder portion 1 forwardly of FIG. 1(b) by engaging the claw 5. The comb 9 is also enclosed in the holder portion 8 as shown in FIG. 1(c), and can be removed from the holder portion 8 by sliding it forwardly of FIG. 1(c). Thus, both the blade and the comb can be replaced with new blade and comb having different shapes. In FIG. 1(a), the comb 9 is mounted in the holder portion 8. But instead, a replacement razor blade may be mounted in the holder portion 8. Thus, the single hairdressing tool according to the present invention can carry razors and combs of different types and shapes.

FIG. 1(d) shows a hairdressing tool of which the blade protector 2 and the razor holder portion 1 are formed as a one-piece member which is hereinafter referred to as a razor holder portion 1a. The hairdressing tool shown in FIG. 1(a) has an advantage in that because the blade protector 2 and the razor holder portion 1 are separate members, the blade protector 2 can be detached from the razor holder portion 1, so that combs and razors of different shapes can be mounted on the razor holder portion 1. The hairdressing tool of FIG. 1(d) has an advantage in that because the razor holder portion 1 and the blade protector 2 are integral with each other, the tool is simple in structure and small in the number of parts, so that the tool of FIG. 1(d) can be manufactured at a low cost.

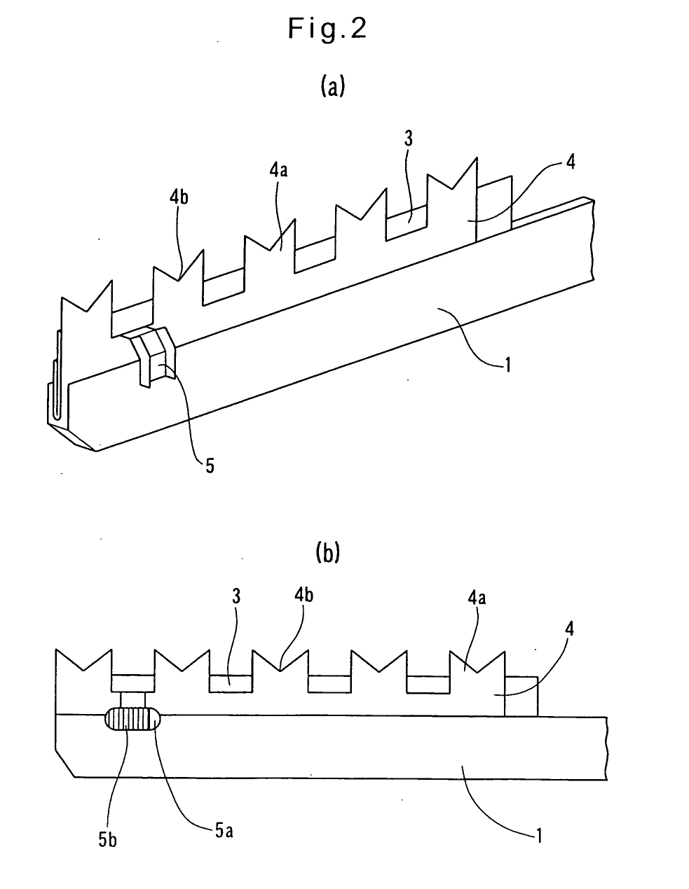

FIG. 2(a) is a perspective view of the blade 3, blade holder 4 and razor holder portion 1 shown in FIG. 1(a). FIG. 2(b) shows a modified embodiment in which the claw 5 shown in FIG. 2(a) is replaced with a different claw 5a. Like elements in FIGS. 2(a) and 2(b) are denoted by like numerals and their description is omitted.

In the embodiment of FIG. 2(a), ribs are formed on both sides of the claw 5. Thus, it is possible to change the width of the portions of the blade exposed both between the adjacent protrusions 2a and between the adjacent protrusions 4a by sliding the blade holder 4 in the razor holder portion 1 with a finger in engagement with the ribs of the claw 5 even while hair is being cut with the hairdressing tool.

In the embodiment of FIG. 2(b), instead of the ribs, the claw 5 is formed with a non-slip means 5b comprising narrow grooves or narrow ribs. By providing the non-slip means, it is possible to slide the blade holder 4 with one finger, so that it is possible to use both the comb and razor for hair-cutting, and also to adjust the width of the exposed portions of the blade 3 with one hand. Work efficiency thus improves.

The claw 5 may be provided at a portion other than the end of the blade holder remote from the grip 6, but has to be provided at a portion where the claw will not interfere with hair-cutting. In the embodiments of FIGS. 1 and 2, the claw 5 is provided at a portion where the blade 3 is exposed, but may be provided where a protrusion 4a is provided. The claw 5 should be provided so as not to offer resistance when cutting hair.

Description is now made on how the amount of hair to be cut is adjusted with reference to FIGS. 3(a) to 3(d).

FIG. 3(a) shows the hairdressing tool embodying the invention in which the blade protector 2 and the blade holder 4 are transversely aligned with each other. FIG. 3(b) shows hair that has been cut by the hairdressing tool embodying the invention with the protector 2 and the blade holder 4 arranged as shown in FIG. 3(a). FIG. 3(c) shows the hairdressing tool embodying the invention in which the protector 2 and the blade holder 4 are not transversely aligned with each other. FIG. 3(d) shows hair that has been cut by the hairdressing tool embodying the invention with the protector 2 and the blade holder 4 arranged as shown in FIG. 3(c). In FIGS. 3(a) to 3(d), elements that have already been shown in FIGS. 1 and 2 are denoted by identical numerals and their description is omitted.

When the tool according to the invention is moved through hair, some of individual hairs partially engage the cutouts 2b and 4b and thus are left uncut, while the other hairs are cut by the portions of the blade 3 that are exposed between the adjacent protrusions 2a and between the adjacent protrusions 4a.

In the state of FIG. 3(a), since the protrusions 4a of the blade holder 4 and the protrusions 2a of the blade protector 2 are transversely aligned with each other, the width of the exposed portions of the blade 4 is equal to the distance 3a between the adjacent protrusions 4a. Thus, as shown in FIG. 3(b), hairs that engage the protrusions 4a are left uncut and the remaining hairs, i.e. hairs between the adjacent protrusions 4a are cut by the blade 3. Numeral 10a indicates the shape of the thus cut hair.

In the state of FIG. 3(c), the protrusions 4a of the blade holder 4 and the protrusions 2a of the blade protector 2 are offset from each other. The blade holder 4 can be slid in the razor holder portion 1 to the position of FIG. 3(c) by engaging the claw 5 with a finger. In the state of FIG. 3(c), the width 3b of the exposed portions of the blade 3 is narrower than the width 3a shown in FIG. 3(a). Thus, as is apparent from FIG. 3(c), hairs that engage either the protrusions 2a or the protrusions 4a, i.e. hairs in the intervals indicated by 3c, are left uncut, and only hairs in the intervals indicated by 3a are cut. Thus, it is possible to reduce the amount of hair cut compared to the hair 10a shown in FIG. 3(b).

In the arrangement of Patent document 1, in order to change the amount of hair to be cut, it was necessary to prepare a plurality of holder portions which are different in the width of the protrusions from each other. According to the present invention, by sliding the blade holder 4 in the razor holder portion 1 while cutting hair, it is possible to freely change the width of the exposed portions of the blade and thus to freely change the amount of hair to be cut.

1. A hairdressing tool comprising a grip and a razor portion including a blade and coupled to said grip, characterized in that said razor portion comprises a razor holder portion coupled to said grip, a blade holder retaining said blade and detachably mounted to said razor holder portion, said blade holder including a plurality of first comb-shaped protrusions each formed with a cutout for retaining hair, and a blade protector provided separately from said blade holder and including a plurality of second comb-shaped protrusions each formed with a cutout for retaining hair, said blade being exposed between the adjacent first protrusions and between the adjacent second protrusions, said blade holder or said blade protector being slidable such that the width of portions of said blade exposed between the adjacent first protrusions and between the adjacent second protrusions is changeable.

2. The hairdressing tool of claim 1 wherein one of said blade holder and said blade protector is provided with a claw with which a finger is engageable so that said one of said blade holder and said blade protector can be slid by engaging said claw with a finger.

3. The hairdressing tool of claim 1 wherein said razor holder portion and said blade protector are integral with each other.

4. The hairdressing tool of claim 2 wherein said razor holder portion and said blade protector are integral with each other.
